(19) United States
(12) Patent Application Publication
(10) Pub. No.: US 2007/0077811 A1
(43) Pub. Date: Apr. 5, 2007

(54) Integrated connector including both data and power signals

(76) Inventors: Eugene Yong Sik Kim, Mt. View, CA (US); Bartley K. Andre, Menlo Park, CA (US); Eugene Whang, San Francisco, CA (US); Brett William Degner, Menlo Park, CA (US); Tang Yew Tan, San Francisco, CA (US); Aaron Meyer Leiba, Palo Alto, CA (US)

Correspondence Address: SAWYER LAW GROUP LLP, P O BOX 51418, PALO ALTO, CA, 94303, US

(21) Appl. No.: 11/241,066

(22) Filed: Sep. 30, 2005

(51) Int. Cl. H01R 13/60

(52) U.S. Cl. 439/540.1

(57) ABSTRACT

An integrated connector in accordance with the present invention is disclosed which can be connected to two separate data and power plugs or to one integrated data and power plug. Although the connector visually appears to the end user as two distinct ports (data and DC power), it is a single, unified connector from the system's perspective. This design facilitates precise mechanical alignment when a single integrated plug, with both data and DC power, is interfaced with the connector. However, since the single integrated connector presents two ports to the user, it also allows the individual interfaces to be utilized with their own respective plug.

### FIELD OF THE INVENTION

The present invention relates generally to a connector specifically to a connector that includes both data and power signal.

### BACKGROUND OF THE INVENTION

Connectors are utilized extensively on devices that need both data and power transfer. Typically on devices the transfer of data and power is accomplished by the use of two separate connectors; that is, there is a connector for the power and a separate connector for the data transfer and neither connector is related to the other. In many devices that have docking stations such as an iPod or the like, there is a single unified connector that allows for the transfer of both power and data to the device.

However, in a typical laptop computer, a user is presented with one cable for power and another cable or set of cables for data transfer. If a docking station is utilized, however, it is desirable to provide a unified connector. Typically, when using a docking station, it can be difficult to get the two connectors to be discretely aligned.

There are a variety of issues between the two connectors that affect this alignment. For example, there are two issues between the two connectors that can affect alignment. One is the problem of accurate horizontal alignment between the connectors. In addition, there are alignment issues related to the features of the computer to be assembled, the computer and the printed circuit board, which typically would need to be addressed to provide correct alignment.

Accordingly, what is needed is a single unified connector for both data and power that from the user perspective could present a separate cable and when used as a docking station would allow for alignment without requiring the precise tolerances based on the device it is being connected with (such as a laptop computer). Such a unified connector should be easy to implement, cost-effective, and should be adaptable to existing environments. The present invention addresses such a need.

### SUMMARY OF THE INVENTION

An integrated connector in accordance with the present invention is disclosed which can be connected to two separate data and power plugs or to one integrated data and power plug. Although the connector visually appears to the end user as two distinct ports (data and DC power), it is a single, unified connector from the system's perspective. This design facilitates precise mechanical alignment when a single integrated plug, with both data and DC power, is interfaced with the connector. However, since the single integrated connector presents two ports to the user, it also allows the individual interfaces to be utilized with their own respective plug.

### BRIEF DESCRIPTION OF THE DRAWINGS

FIG. 1 illustrates a front view of a connector in accordance with the present invention.

FIG. 2 illustrates a back view of a connector in accordance with the present invention.

FIG. 3A illustrates a front view of a connector in accordance with the present invention.

FIG. 3B illustrates a side view of a connector in accordance with the present invention.

FIG. 3C illustrates a bottom view of a connector in accordance with the present invention.

FIG. 4 illustrates a bottom view of a connector in accordance with the present invention.

FIG. 5 illustrates a connector in accordance with the present invention coupled to a unified plug.

FIG. 6 shows the connector in accordance with the present invention with a device.

FIG. 7 is a perspective view of a device which utilizes a connector in accordance with the present invention.

### DETAILED DESCRIPTION

The present invention relates generally to a connector and more specifically to a connector that includes both data and power signals. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

A single integrated connector in accordance with the present invention is disclosed which can be connected to two separate data and power plugs or to one integrated data and power plug. Although the connector visually appears to the end user as two distinct ports (data and DC power), it is a single, unified connector from the system's perspective. This design facilitates precise mechanical alignment when a single integrated plug, with both data and DC power, is interfaced with the connector. However, since the single integrated connector presents two ports to the user, it also allows the individual interfaces to be utilized with their own respective plug.

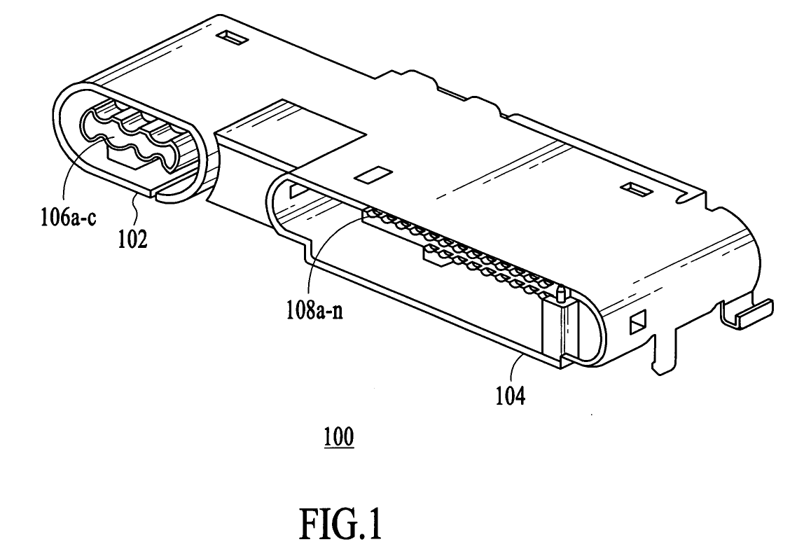

To describe the features of the present invention in more detail, refer now to the following discussion in conjunction with the accompanying figures. FIG. 1 illustrates a front view of a connector system 100 in accordance with the present invention. The connector system comprises a body portion 101 which includes two ports, a power port 102 and a data transfer port 104. The power port 102 comprises three pins, 106a-106c. The data transfer port 104 comprises pins 108a-108n.

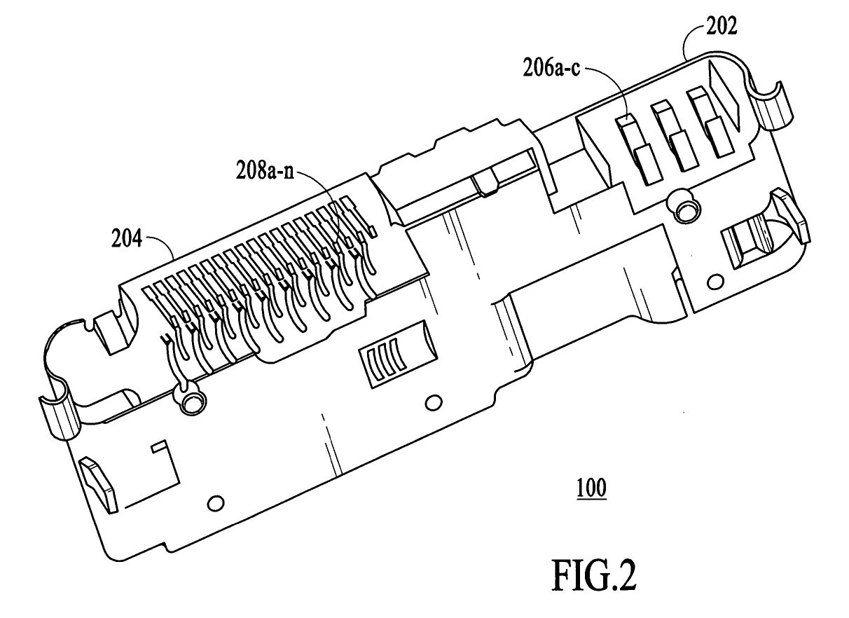

FIG. 2 illustrates a back view of a connector system 100 in accordance with the present invention. The connector system comprises a power connection area 202 and a data transfer area 204. The power connection area 202 includes connection pins 206a-206c. The data transfer area includes connections 208a-n.

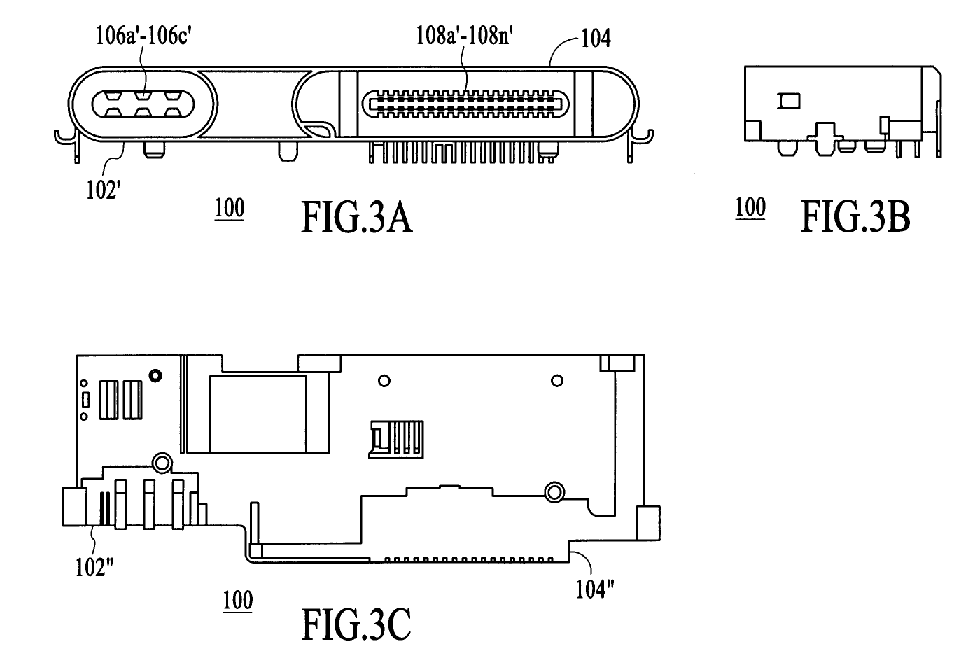

FIG. 3A illustrates a front view of a connector 100 in accordance with the present invention. The power port 102′ and data transfer port 104′ are shown. Also shown are the power connection pins 106a′-106c′ and data transfer pins 108a′-108n′.

FIG. 3B illustrates a side view of a connector 100 in accordance with the present invention.

FIG. 3C illustrates a bottom view of a connector 100 in accordance with the present invention. A bottom view of the power port 102″ and data transfer port 104″ are shown.

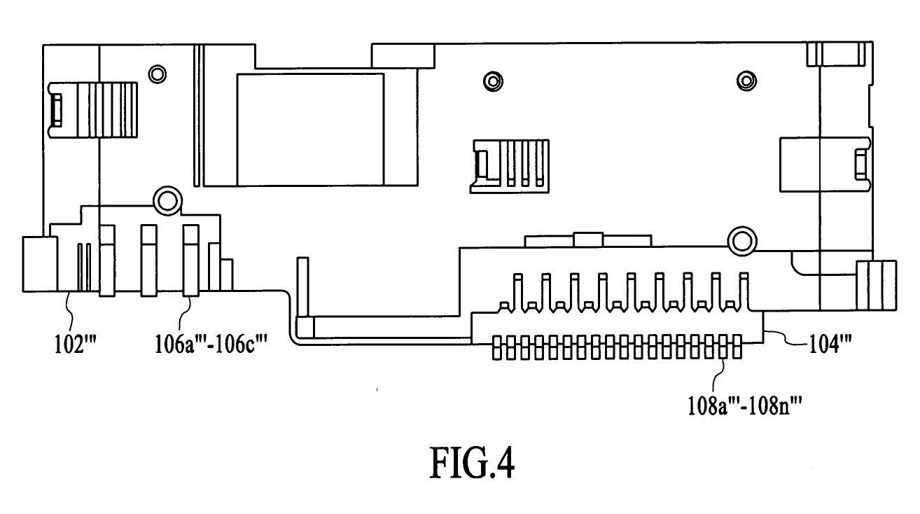

FIG. 4 illustrates another bottom view of a connector 100 in accordance with the present invention. Details of the power port 102′″ and data transfer port 104′″ are shown. Also shown are power connection pins 106a′″-106c′″ and data transfer pins 108a′″-108n′″.

TABLE 1

| | | Port | Pin | Total Pin |
|---|---|---|---|---|
| I/O | Signal Description | Quantity | Count | Count |
| USB 2.0 | USB_P | 2 | 2 | 4 |
| | USB_M | | | |
| Firewire 400 | TPA_P | 1 | 4 | 4 |
| | TPA_M | | | |
| | TPB_P | | | |
| | TPB_M | | | |
| USB Power | +5 V_USB PWR | 1 | 2 | 2 |
| | USB_PWR_GND | | | |
| Firewire Power | +12_VW_PWR | 1 | 2 | 2 |
| | FW_PWR_GND | | | |
| Analog Audio | AUD_OUT_L | 1 | 4 | 4 |
| | AUD_OUT_R | | | |
| | AUD_RTN_GND | | | |
| | AUD_RTN_BND | | | |
| Digital Audio | DIG_AUD_OUT | 1 | 2 | 2 |
| | DIG_AUD_RTN_G | | | |
| Composite | VID_COMP_OUT | 1 | 4 | 4 |
| Video | VID_LUM_OUT | | | |
| | VID_BW_OUT | | | |
| | VID_RTN_GND | | | |
| Detection Pins | DETECT | 8 | 1 | 8 |
| DC Power | DC POWER | 1 | 4 | 4 |

DC Power: 12 V@4 Ampere

Table 1 shows the I/O specifications for the type of signal being transferred, port quantity, pin count, and total pin count.

As can be seen in Table 1, a variety of combinations of ports and pins can be used for data transfer and power transfer, depending upon the requirements of the devices being connected via the connector. One should understand, however, that a connector system in accordance with the present invention is not limited to these pins or combination of pins. One of ordinary skill in the art readily recognizes various pins and their combination could be utilized and their use would be within the spirit and scope of the present invention.

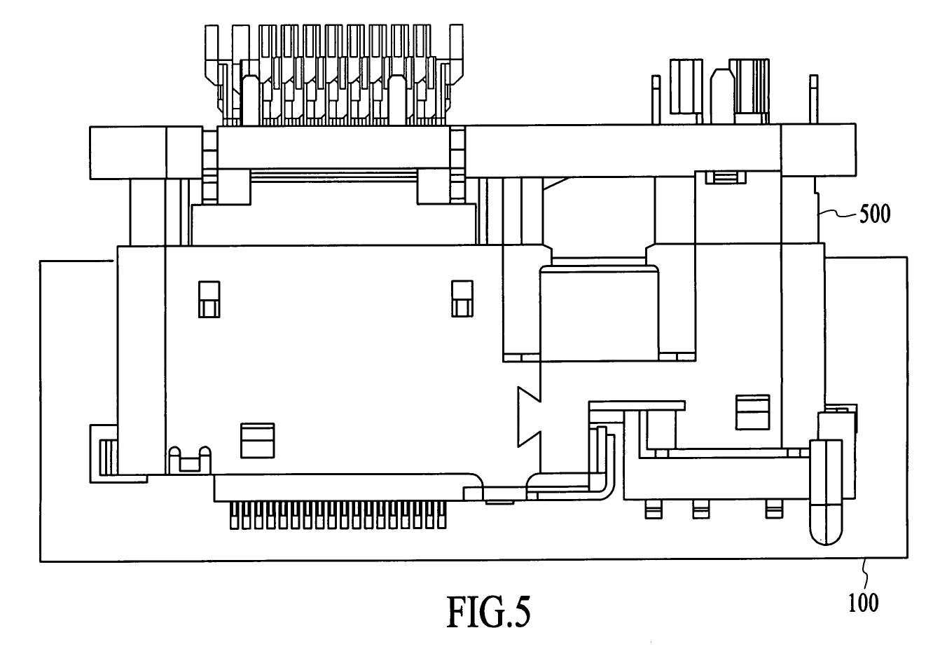

FIG. 5 illustrates a connector 100 in accordance with the present invention coupled to a unified plug 500. Although the connector 100 shown is coupled to a unified plug 500, two separate plugs for DC power and data could also be coupled to the connector 100.

Accordingly, what is provided is a connector which incorporates the standard functionality of a data and signal connector in a single connector. In so doing, a system is provided which is more versatile and can be utilized in a more robust way than previous connector systems. The single connector in accordance with the present invention also overcomes alignment issues typically encountered when multiple connectors are utilized.

One should readily recognize that although the present invention has been described in conjunction with a particular type of connector, this system could be used within a variety of environments and they would be within the spirit and scope of the present invention.

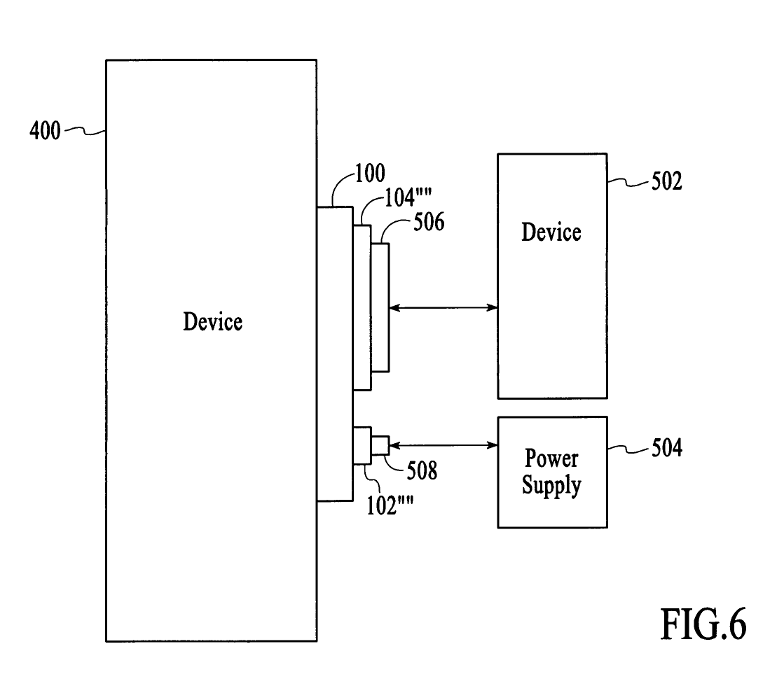

For example, FIG. 6 shows the connector 100 in accordance with the present invention within a device 400, such as an MP3 player, etc. A device 502 such as a memory is connected via a plug to the data port 104″″ of connector 100, and a power supply 504 is connected to the power port 102″″ of connector 100 via a plug. In this embodiment, the connector 100 in accordance with the present invention can be utilized either with separate plugs connecting to data and power or with a unified plug as shown in FIG. 5.

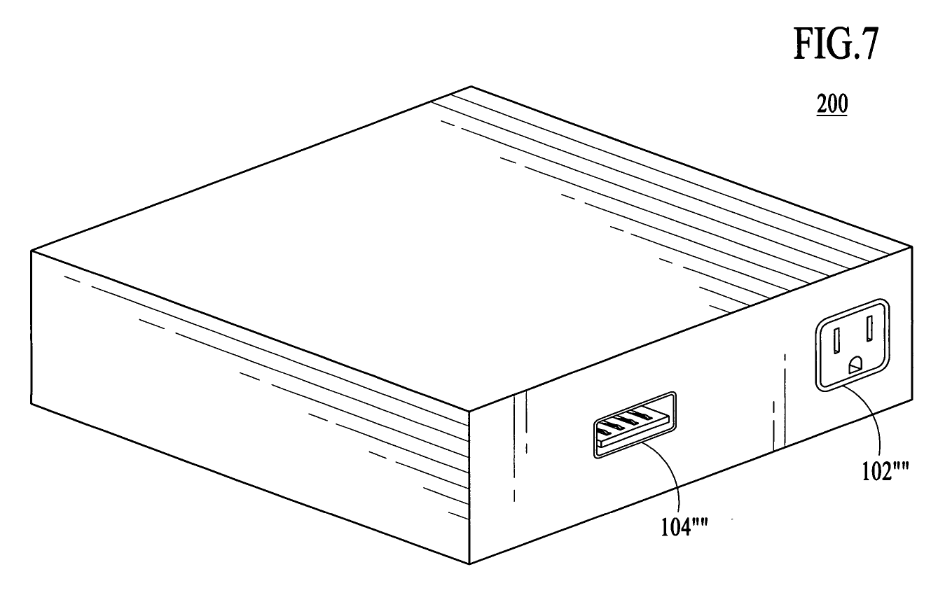

FIG. 7 is a perspective view of a device 200 that includes a connector in accordance with the present invention. As is seen, a data plug can be plugged into data port 104″″ and a power plug can be plugged into power port 102″″.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

1. A connector system comprising:
a connector body;
a first port within the body for coupling to power; and
a second port within the body for coupling to data, wherein the first port comprises a first plurality of pins and the second port comprises a second plurality of pins, wherein the first and second plurality of pins are separated from each other horizontally.

2. (canceled)

3. The connector system of claim 1 wherein the first plurality of pins comprise DC power pins.

4. The connector system of claim 1 wherein the second plurality of pins comprises any combination of USB 2.0, Firewire 400, USB power, Firewire power, analog audio, digital audio, video, detection pins and DC power.

5. The connector system of claim 1 wherein either a unified plug is utilized with the connector system to provide power and data or separate plugs for data and power are utilized with the connector system to provide power and data.

6. An apparatus comprising:
a device; and
a connector system coupled to the device; the connector system comprising a connector body; a first port within the body for coupling to power; and a second port within the body for coupling to data, wherein the first port comprises a first plurality of pins and the second port comprises a second plurality of pins, wherein the first and second plurality of pins are separated from each other horizontally.

7. (canceled)

8. The apparatus of claim 6 wherein the first plurality of pins comprise DC power pins.

9. The apparatus of claim 6 wherein the second plurality of pins comprises any combination of USB 2.0, Firewire 400, USB power, Firewire power, analog audio, digital audio, video and detection pins.

10. The apparatus of claim 6 wherein either a unified plug is utilized with the connector system to provide power and data or separate plugs for data and power are utilized with the connector system to provide power and data.

11. A connector system comprising:
a connector body;
a first port within the body for coupling to power wherein the first port comprises a first plurality of pins wherein the first plurality of pins comprise DC power pins; and
a second port within the body for coupling to data wherein the second port comprises a second plurality of pins wherein the second plurality of pins comprises USB, Firewire, USB power, Firewire power, analog audio, digital audio, video and detection pins.

12. The connector system of claim 11 wherein either a unified plug is utilized with the connector system to provide power and data or separate plugs for data and power are utilized with the connector system to provide power and data.

13. An apparatus comprising:
a device; and
a connector system coupled to the device; the connector system comprising a connector body; a first port within the body for coupling to power; and a second port within the body for coupling to data, wherein the first port comprises a first plurality of pins and the second port comprises a second plurality of pins, wherein the first and second plurality of pins are separated from each other horizontally wherein the first plurality of pins comprise DC power pins, wherein the second plurality of pins comprises USB, Firewire, USB power, Firewire power, analog audio, digital audio, video and detection pins.

14. The apparatus of claim 13 wherein one of a unified plug is utilized with the connector system to provide power and data and separate plugs for data and power are utilized with the connector system to provide power and data.
